(19) United States
(12) Patent Application Publication
(10) Pub. No.: US 2026/0219374 A1
(43) Pub. Date: Jul. 30, 2026

(54) APPROXIMATION OF DISTANCES FOR RADAR IMAGING

(71) Applicant: Kabushiki Kaisha Toshiba, Tokyo (JP)

(72) Inventors: Seifallah JARDAK, Bristol (GB); Mustafa AL-ANI, Bristol (GB)

(73) Assignee: Kabushiki Kaisha Toshiba, Tokyo (JP)

(21) Appl. No.: 19/040,652

(22) Filed: Jan. 29, 2025

(51) Int. Cl. G01S 13/10; G01S 7/292; G01S 13/00; G01S 13/89

(52) U.S. Cl. CPC G01S 13/103; G01S 7/292; G01S 13/006; G01S 13/89

(57) ABSTRACT

Provided is a method of processing radar reflection data received at an antenna array, the antenna array comprising a plurality of antenna elements grouped into at least one array cluster, the radar reflection data being representative of a scene, the scene comprising a plurality of scene resolution cells, the method comprising, for each antenna element: match-filtering the radar reflection data received at the antenna element against a signal model to produce image data, wherein the signal model is calculated using approximated distances between the antenna element and each scene resolution cell, wherein the approximated distance between the antenna element and each scene resolution cell is determined using a distance measured from the centre of the array cluster containing the antenna element.

### FIELD

The present disclosure is in the field of radar technology.

### DESCRIPTION OF DRAWINGS

FIG. 1 is a diagram illustrating reference frames of a radar and an object, in three-dimensional space.

FIG. 2 is a flowchart of a conventional back-projection image formation algorithm.

FIG. 3 is an illustration of a radar array and image with elements grouped into clusters.

FIG. 4 is a flowchart of a back-projection image formation algorithm, according to an embodiment.

FIG. 5A is a graph indicating the normalized maximum sum of array and scene cluster radii as a function of the normalized radar to target range.

FIG. 5B is a graph indicating the maximum sum of array and scene cluster radii as a function of the radar to target range for an exemplary radar wavelength.

FIG. 6 is an illustration of the phase history and range-Doppler data involved to form a segment of a radar image.

FIG. 7 is an illustration of a multiple-input, multiple-output (MIMO) array cluster and a scene cluster.

FIG. 8A is an illustration of a uniform scene cluster subdivision in two-dimensions.

FIG. 8B is an illustration of a non-uniform scene cluster subdivision in two-dimensions.

FIG. 9 is an illustration of the inscribing square and hexagon of a circle.

FIGS. 10A and 10B are radar images formed using the exact computation and the method of FIG. 4 respectively.

FIGS. 11A and 11B are further radar images formed using the exact computation and the method of FIG. 4 respectively.

### DESCRIPTION OF EMBODIMENTS

According to a first embodiment, there is provided a method of processing radar reflection data received at an antenna array, the antenna array comprising a plurality of antenna elements grouped into at least one array cluster, the radar reflection data being representative of a scene, the scene comprising a plurality of scene resolution cells, the method comprising, for each antenna element:
match-filtering the radar reflection data received at the antenna element against a signal model to produce image data, wherein the signal model is calculated using approximated distances between the antenna element and each scene resolution cell, wherein the approximated distance between the antenna element and each scene resolution cell is determined using a distance measured from the centre of the array cluster containing the antenna element.

The plurality of scene resolution cells may be grouped into at least one scene cluster, and the approximated distance between the antenna element and each scene resolution cell may be determined using a distance measured from the centre of the array cluster containing the antenna element to a centre of the scene cluster containing the scene resolution cell.

The approximated distance rₐₛ may be calculated as:

$$\\ {r}_{as} ( n ) \approx {r}_{oc} \times ( 1 + {η}_{cs} α ( n ) + {η}_{oa} β ( n ) ) ,$$

wherein
r_{oc} is the measured distance between the centre of the array cluster and the centre of the scene cluster,
η_{cs} is a ratio between (i) a distance of the scene resolution cell to the centre of the scene cluster and (ii) the measured distance,
ηₒₐ is a ratio between (i) a distance of the antenna element to the centre of the array cluster and (ii) the measured distance,
α(n) is the cosine of the angle formed between the centre of the array cluster, the centre of the scene cluster, and the scene resolution cell, and
β(n) is the cosine of the angle formed between the antenna element, the centre of the array cluster and the centre of the scene cluster.

The approximated distance rₐₛ may be calculated as:

$$\\ {r}_{as} ( n ) \approx {r}_{oc} \times ( 1 + {η}_{cs} α ( n ) + {η}_{oa} β ( n ) + \frac{{η}_{cs}^{2}}{2} ( 1 - {α ( n )}^{2} ) + \frac{{η}_{oa}^{2}}{2} ( 1 - β {( n )}^{2} ) + {η}_{oa} {η}_{cs} ( γ ( n ) - α ( n ) β ( n ) ) )$$

wherein
r_{oc} is the measured distance between the centre of the array cluster and the centre of the scene cluster,
η_{cs} is a ratio between (i) a distance of the scene resolution cell to the centre of the scene cluster and (ii) the measured distance,
ηₒₐ is a ratio between (i) a distance of the antenna element to the centre of the array cluster and (ii) the measured distance,
α(n) is the cosine of the angle formed between the centre of the array cluster, the centre of the scene cluster, and the scene resolution cell,
β(n) is the cosine of the angle formed between the antenna element, the centre of the array cluster and the centre of the scene cluster, and
γ(n) is the cosine of the angle formed between (i) the vector spanning from the antenna element to the centre of the array cluster, and (ii) the vector spanning from the centre of the scene cluster to the scene resolution cell.

The plurality of scene resolution cells may be grouped into a plurality of scene clusters, wherein a size of a scene cluster increases as its measured distance from the array cluster increases.

At least one of the array clusters, and/or at least one of the scene clusters, may be hexagonally shaped.

The radar reflection data may comprise reflections obtained from a pulse signal emitted from the radar towards the scene, and the method may be performed for a plurality of emitted pulse signals.

The antenna array may be a MIMO radar, and/or the plurality of antenna elements may be mmWave antenna elements.

According to another embodiment, there is provided a computer system configured to perform any of the methods described above.

According to a further embodiment, there is provided a non-transitory computer-readable medium comprising computer executable instructions that when executed by a computer will cause the computer to perform any of the methods described above.

Radar imaging is useful for military and civil applications such as mapping and surveying an area of interest from the sky, controlling sea borders, or predicting weather conditions. A radar with a single antenna and a single pulse can only resolve scatterers in range. To construct a two- or three-dimensional radar image, scatterers should also be resolved in azimuth or/and elevation. Radar imaging methods often comprise processing phase histories captured from multiple antennas, multiple pulses, or a combination of both. Inverse synthetic aperture radar, or ISAR, in an imaging technique that exploits the motion of the target during the scanning period to resolve scatterers, using Doppler effects.

To form a high-resolution image using ISAR, the captured radar data from an antenna element is match-filtered with a signal model constructed for the antenna element to obtain the contribution of each image pixel. This is often referred to as back-projection. With large MIMO scanners, the target is often static, and so the signal model can be computed once and stored for quick access. This precomputation step is very convenient, and saves on processing time during operation. However, in ISAR applications, the model depends on the estimated motion of the target, and so the model cannot be precomputed. Hence, there is a need to reduce the computation time of the signal model to improve performance of the radar.

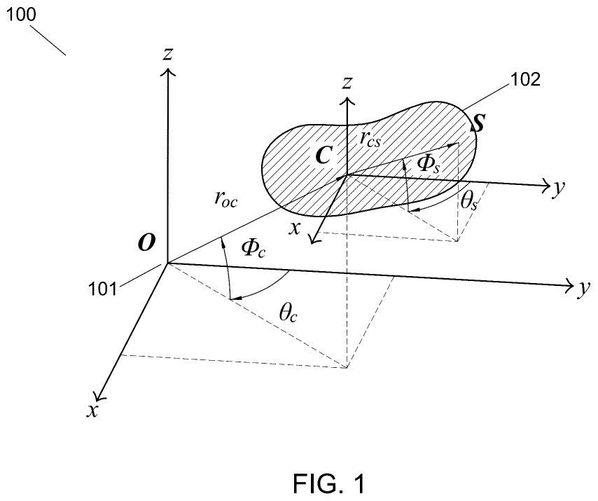

FIG. 1 illustrates an example radar imaging system 100. The radar imaging system 100 includes a radar 101, located at origin O. The radar 101 may wish to image a scene 102 including a target object, with centre C. The distance between the radar 101 and the centre of the scene C may be defined as r_{oc}. The scene 102 may be comprised of a plurality of scatterers S.

The range rₒₛ from a radar located at origin O to any scatterer S in a scene with centre C can be expressed as

$$\\ \begin{matrix}{r}_{as} ( n ) = \vert \vec{OS} \vert = \sqrt{{\vert \vec{OC} \vert}^{2} + 2 < \vec{OC} , \vec{CS} > + {\vert \vec{CS} \vert}^{2}} = \sqrt{{r}_{oc}^{2} + 2 {r}_{oc} {r}_{cs} α ( n ) + {r}_{cs}^{2}} = {r}_{oc} \times \sqrt{1 + 2 {η}_{cs} α ( n ) + {η}_{cs}^{2}} & ( 1 )\end{matrix}$$

where r_{oc} and r_{cs} denote the distances separating the radar to scene centre, and scene centre to scatterer respectively. Their ratio is denoted by

$$\\ {η}_{cs} = \frac{{r}_{cs}}{{r}_{oc}} .$$

The term

$$\\ α = \frac{< \vec{OC} , \vec{CS} >}{{r}_{oc} {r}_{cs}}$$

is the cosine of the angle [symbol] , formed between the radar, scene centre, and scatterer. As the rigid target object spins around its centre, a varies and depends on the time sample n. For a general movement where the target can translate, r_{oc} also varies in time. In such case, a motion compensation method stabilizes the target centre on a given range cell.

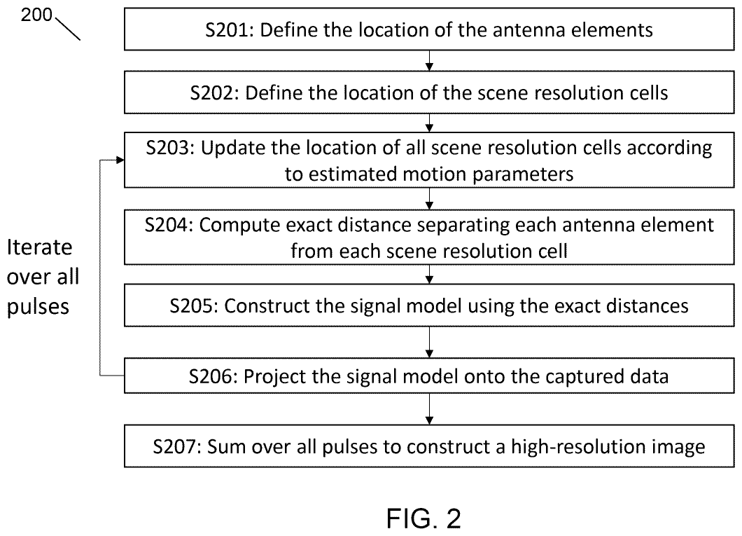

Back-projection (BP) is a robust imaging technique that correlates the radar phase history with a constructed model. The conventional method 200 for performing back-projection is illustrated in FIG. 2.

The method 200 commences with step S201, in which the location of the antenna elements is defined. The radar 101 may comprise an array of antenna elements, which are distributed throughout the space defined by the radar 101. The location of these antenna elements relative to the origin O may be determined and stored for use in constructing the signal model.

At step S202, the location of the scene resolution cells may be determined. The location of the scene resolution cells is chosen based on the region of interest for imaging. Each scene resolution cell may comprise a number of scatterers S of the scene 102. The contribution of the scatterers comprised within a single scene resolution cell may be represented by a single pixel in the final image. The location of each scene resolution cell relative to the origin O may be determined and stored for use in constructing the signal model.

At step S203, the location of all scene resolution cells may be updated according to estimated motion parameters. The motion parameters may be estimated based on the captured radar data. The motion parameters may also be estimated using an external sensor, such as a camera, or a motion sensor on the target, capable of tracking and providing the estimated motion parameters.

At step S204, the exact distance separating each antenna element from each scene resolution cell is calculated analytically, using the known locations of the antenna elements and the scene resolution cells. This step is responsible for a large portion of the computational time required to perform method 200. For a system of M antenna elements and N resolution cells, this requires MN separate calculations of unique distances between antenna elements and resolution cells, amounting to roughly a third of the total computational time.

At step S205, the distances calculated in step S204 are used to calculate the signal model for each antenna element. The signal model acts as a matched-filter, and can be expressed as

$$\\ exp \{ - \frac{4 i π {f}_{c} ( 2 {r}_{as} )}{c} ) \} ,$$

wherein i represents the imaginary unit where i²=−1, f_{c} is the signal frequency, 2rₐₛ represents the two-way distance between the antenna element and the scene resolution cell, and c represents the speed of the pulse.

At step S206, the signal model is projected onto the captured data. The captured data is match-filtered with the signal model, resulting in phase history data representative of each image resolution cell. The method of FIG. 2 depicts an offline mode of operation, where the data has already been captured at a previous time while the target was moving, and motion parameters are estimated. However, the method can also be carried out with simultaneous scanning and imaging.

Steps S203 to S206 may be performed for a single pulse emitted from the radar 101.

The radar 101 may emit multiple pulses across a period of time. Steps S203 to S206 may be performed for each pulse emitted.

At step S207, the phase history data obtained from each pulse may be combined to form a complete set of phase history data. This phase history data may then be processed to form a full high-resolution image.

The computation of exact distances from each antenna element to every resolution cell is costly. Therefore, there is a desire to simplify and linearize the distance computation step for real-time applications.

The distance computation can be approximated using a truncated Taylor series. However, to limit the approximation error, the large scene volume can be subdivided into smaller clusters defined by a radius and their respective centres. Additionally or alternatively, the antenna scanner can also be subdivided into smaller array clusters.

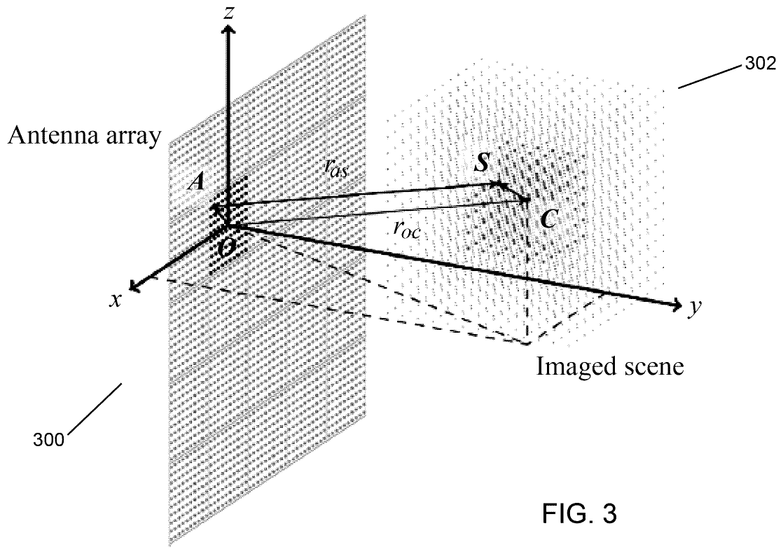

FIG. 3 illustrates an example system 300, comprising an antenna array 301 and an imaged scene 302. The antenna array 301 comprises a plurality of individual antenna elements A. The antenna elements are grouped into clusters—for illustration purposes, in FIG. 3, antenna elements comprised within the same cluster as the antenna element A are indicated in a darker gray than the antenna elements belonging to other clusters.

The imaged scene 302 comprises a plurality of scene resolution cells S. The scene resolution cells are also grouped into clusters—for illustration purposes, in FIG. 3, scene resolution cells comprised within the same cluster as the scene resolution cell S are indicated in a darker gray than the scene resolution cells belonging to other clusters.

For the purposes of example, FIG. 3 and the discussion below relate to the use of clustering in both the imaged scene and the antenna array to maximize the reduction in computation time. However, it should be understood that it is not required for both the scene resolution cells and the antenna elements to be clustered, and that in some embodiments only the scene resolution cells or only the antenna elements may be clustered.

The range rₐₛ=|AS| between an antenna element A in a cluster with centre O and a scene resolution cell S in a cluster with centre C is as follows:

$${r}_{as} ( n ) = \sqrt{{r}_{oc}^{2} + 2 {r}_{oc} {r}_{cs} α ( n ) + 2 {r}_{oc} {r}_{oa} β ( n ) + 2 {r}_{oa} {r}_{cs} γ ( n ) + {r}_{cs}^{2} + {r}_{oa}^{2}} = {r}_{ox} \times \sqrt{1 + 2 {η}_{cs} α ( n ) + 2 {η}_{oa} β ( n ) + 2 {η}_{cs} {η}_{oa} γ ( n ) + {η}_{cs}^{2} + {η}_{oa}^{2}} \qquad ( 2 )$$

where rₒₐ, r_{oc}, and r_{cs} are the ranges |OA|, |OC|, and ICSI respectively. ηₓ denotes the ratio

$$\frac{{r}_{x}}{{r}_{o c}}$$

and the terms α, β and γ are defined as:

$$α ( n ) = \frac{< \vec{OC} , \vec{CS} >}{{r}_{oc} {r}_{cs}} , β ( n ) = \frac{< \vec{AO} , \vec{OC} >}{{r}_{oc} {r}_{oa}} , γ ( n ) = \frac{< \vec{AO} , \vec{CS} >}{{r}_{ao} {r}_{cs}} .$$

Equation (2) can be expressed using the Taylor expansion of \sqrt{(1+x)} and truncated at either the first or second order to obtain the following two expressions, respectively:

$$\times ( 1 + {η}_{cs} α ( n ) + {η}_{oa} β ( n ) ) , \qquad ( 3 )$$

$$\times ( 1 + {η}_{cs} α ( n ) + {η}_{oa} β ( n ) + \frac{{η}_{cs}^{2}}{2} ( 1 - {α ( n )}^{2} ) + \frac{{η}_{oa}^{2}}{2} ( 1 - {β ( n )}^{2} ) + {η}_{oa} {η}_{cs} ( γ ( n ) - α ( n ) β ( n ) ) ) . \qquad ( 4 )$$

Equation (3) represents the first order truncation, with only linear terms preserved, whilst equation (4) represents the second order truncation, which preserves both linear and quadratic terms. The second order truncation introduces more complexity into the computation, but reduces the error in the computation caused by the truncation. The approximation error is dependent on the ratio between the radius of the scene cluster and array cluster with respect to the distance to the radar, i.e.

$${η}_{c s} = \frac{{r}_{c s}}{{r}_{o c}} and {η}_{o a} = \frac{{r}_{oa}}{{r}_{o c}} .$$

In the above expression, the vector \vec{AO} is fixed and defines the array cluster layout. The general target motion can be decomposed into a translation and a rotation around the target centre. \vec{OC} depends on the target translation, while CS rotates following the target's rotational rate. Therefore, in cases where there is no translation or relative rotation, the expression of the approximation can be further simplified.

Exact values of the range to the target and the angle between the centre of the scene and a given scene resolution cell are not required during scanning for each pulse. Instead, it is enough that averages of these values are known, such that an appropriate limit can be set on the size of the antenna clusters and/or the size of the scene clusters, to ensure approximation error remains within an acceptable value.

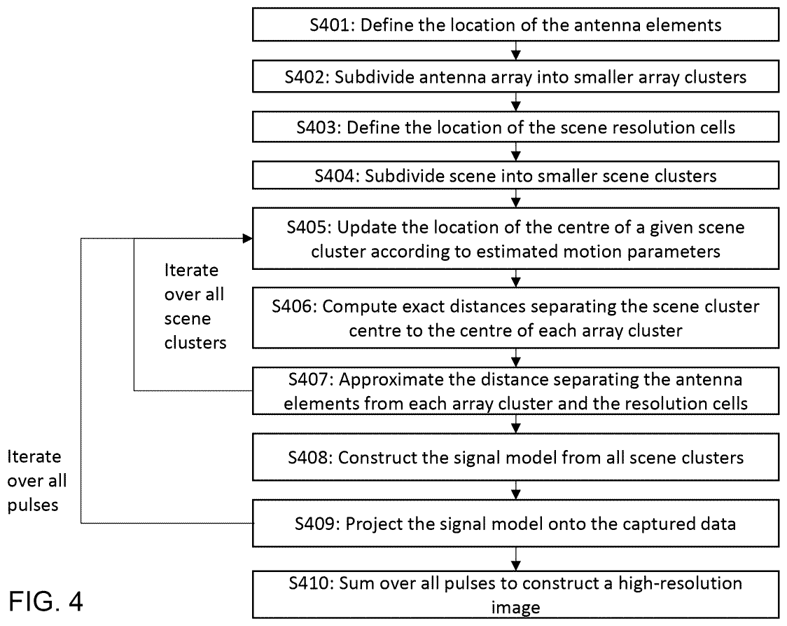

FIG. 4 presents a method for performing back projection according to embodiments. Instead of computing the exact distances from all antenna elements to all scene resolution cells, the exact distances separating centres of clusters may be calculated. This reduces the amount of exact distances which need to be calculated, hence reducing the computational expense incurred. In some embodiments where only the antenna elements are clustered, the exact distances between the centres of the array clusters to each scene resolution cell may be calculated. In other embodiments where only the scene resolution cells are clustered, the exact distances between the centre of each scene cluster to each antenna element may be calculated.

For illustrative purposes, FIG. 4 concerns an embodiment with clustering in both the antenna elements and the scene resolution cells, where exact distances need only be calculated between the centre of each array cluster to the centre of each scene cluster. The distance between each antenna element of the array cluster to each scene resolution cell of the scene cluster is approximated using the Taylor expansion. This approximation may be either linear, using expression (3), or quadratic, using expression (4), depending on the size of the clusters and the approximation requirements.

The method 400 commences with step S401, in which the locations of the antenna elements are defined. The radar 301 may comprise an array of antenna elements, which are distributed throughout the space defined by the radar 301. At step S402, the antenna elements are divided into one or more array clusters, wherein each array cluster contains a plurality of antenna elements.

At step S403, the location of the scene resolution cells may be determined. Each scene resolution cell may comprise a number of scatterers S of the scene 102. The contribution of the scatterers comprised within a single scene resolution cell may be represented by a single pixel in the final image. At step S404, the scene resolution cells may be grouped into one or more scene clusters, wherein each scene cluster contains a plurality of scene resolution cells.

At step S405, the location of a particular scene cluster may be updated according to estimated motion parameters. As discussed above, the motion parameters may be estimated based on the captured radar data, or by using an external sensor such as a camera or a motion sensor on the target, capable of tracking and providing the estimated motion parameters.

At step S406, the exact distance separating the centre of the particular scene cluster from the centre of each array cluster is calculated. As there are fewer array clusters than individual antenna elements and fewer scene clusters than scene resolution cells, the amount of distances required to be calculated in this step is greatly reduced when compared to step S204 of the previous method.

At step S407, the exact distances calculated in step S406 are used to approximate the distances separating the antenna elements in each array cluster from the scene resolution cells in the given scene cluster. Either of equations (3) or (4) may be used to approximate the distance between the antenna elements and the scene resolution cells.

If the approximation is applied on both elements of the array and scene clusters, the sum of the two radii of the different cluster types should be smaller than a fraction of the wavelength:

$${r}_{c s} + {r}_{o a} = \sqrt{2 {ϵλ}_{c} {r}_{o c}} \qquad ( 5 )$$

when truncating the Taylor expression at the first order, or

$${r}_{c s} + {r}_{o a} = \sqrt[3]{3 \sqrt{3} ε {λ}_{c} {r}_{o c}^{2}} \qquad ( 6 )$$

when truncating the Taylor expression at the second order, where E represents the acceptable limit set on the approximation error.

The approximated ranges are used to resolve scatterers in elevation and azimuth. Hence, the size of the cluster is relative to the wavelength. In general, if the size of the array cluster is a factor of the size of the scene cluster, i.e. rₒₐ=xr_{cs}, the limits are weighted as follows:

$${r}_{c s} = \frac{1}{x + 1} \sqrt{2 {ϵλ}_{c} {r}_{o c}} and {r}_{o a} = \frac{x}{x + 1} \sqrt{2 {ϵλ}_{c} {r}_{o c}}$$

when truncating at the first order, or

$${r}_{c s} = \frac{1}{x + 1} \sqrt[3]{( 3 \sqrt{3} {ϵλ}_{c} {r}_{o c}^{2}} and {r}_{o a} = \frac{x}{x + 1} \sqrt[3]{( 3 \sqrt{3} {ϵλ}_{c} {r}_{o c}^{2}}$$

when truncating at the second order.

Steps S405 to S407 are performed for each scene cluster comprised in the scene.

At step S408, the signal model is constructed, using the approximated distances obtained from equations (3) or (4).

At step S409, the signal model is projected onto the captured data. The captured data is match-filtered with the signal model, resulting in phase history data representative of each image resolution cell.

Steps S405 to S409 may be performed for a single pulse emitted from the radar 301. The radar 101 may emit multiple pulses across a period of time. Steps S405 to S409 may be performed for each pulse emitted, capturing the change of location of the target as the target moves between pulses.

At step S410, the phase history data obtained from each pulse may be combined to form a complete set of phase history data. This phase history data may then be processed to form a full high-resolution image.

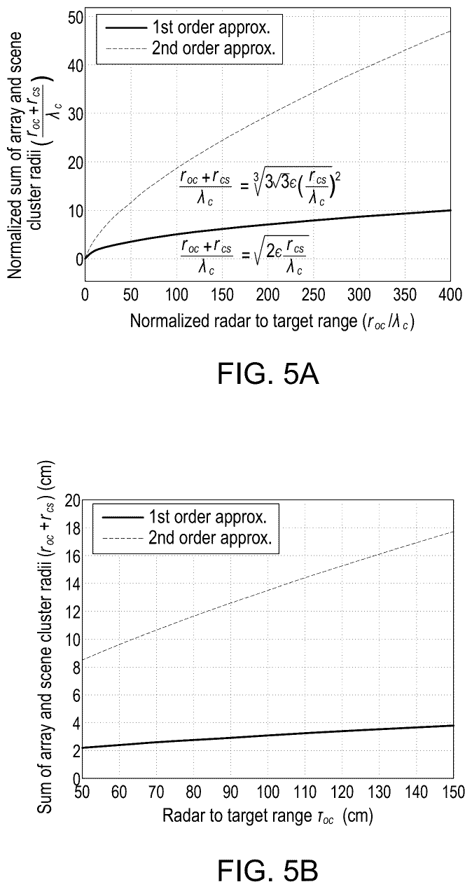

FIG. 5A plots the normalized maximum sum of array and scene cluster sizes as the range to the target varies, whilst maintaining an approximation error below

$$ϵ = \frac{1}{8} .$$

FIG. 5B shows an example plot for mmWave band, with a wavelength λ_{c} equal to 3.8 mm. FIG. 5B demonstrates that at a range of 1 m from the radar, the sum of array and scene cluster radii should not exceed 3 cm when using the first order approximation (equation (3)), or 13.5 cm when using the second order approximation (equation (4)). Hence, the second order approximation allows for the size of array and scene clusters to increase by approximately a factor of 20 for 2D imaging, and approximately a factor of 90 for 3D imaging.

The approximation error depends on the size of the array and scene clusters. However, the computational gain depends on their density. Hence, with more antenna elements per array cluster, and more resolution cells per scene cluster, the distances can be evaluated more efficiently using linear or quadratic expansions.

Often, the antenna elements are spaced at half wavelength distances apart. As a result, an array cluster can include approximately N² elements, where

$$N = 4 \frac{{r}_{oa}}{{λ}_{c}} = 2 \sqrt[3]{\frac{3 \sqrt{3} ϵ {r}_{o c}^{2}}{{λ}_{c}^{2}}} \qquad ( 7 )$$

For example, a relatively small array cluster of 7 cm radius can fit 70×70 elements at half wavelength interspacing.

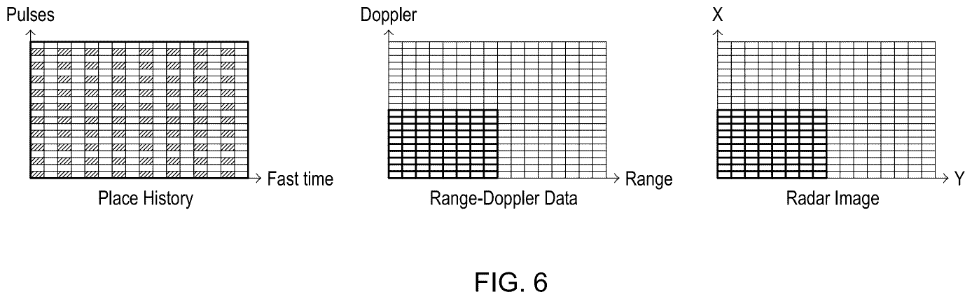

The proposed subdivision of the array and scene into clusters for efficient computation of distances can be combined with the Quadtree back projection image segmentation algorithm. As illustrated in FIG. 6, Quadtree BP segments the data to reduce the number of range profiles involved in the computation of an image pixel. It subdivides the range-Doppler profiles and the antenna arrays into smaller groups and processes them separately to form smaller scene clusters. The subdivision can be carried out iteratively until the number of operations in a single BP block is optimal for the hardware. Therefore, the distance between the antenna and image pixel elements at the last QBP depth can be approximated using the proposed method.

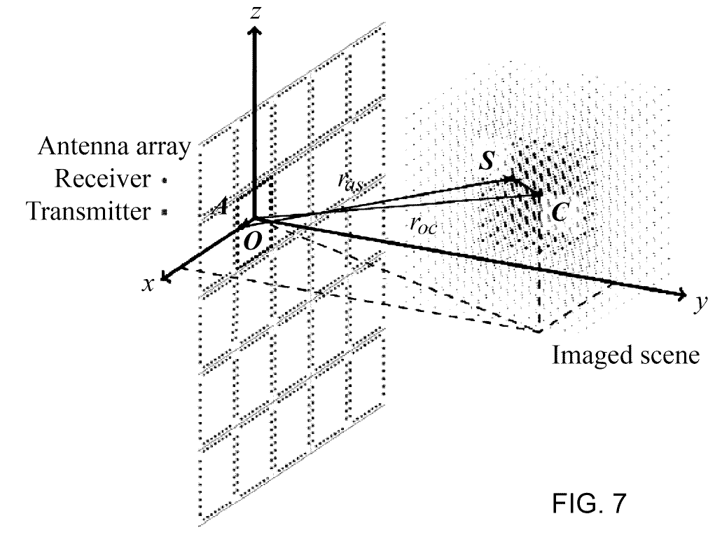

Radar often relies on multiple transmitters and receivers in a MIMO setting to improve angle resolution. If the transmitters and receivers are co-located, the centre of the array cluster can be chosen in the middle of the generated virtual array. Alternatively, the transmitters and receivers can be located further apart, as illustrated in FIG. 7. Each block of co-located antenna elements can be treated as a separate array cluster.

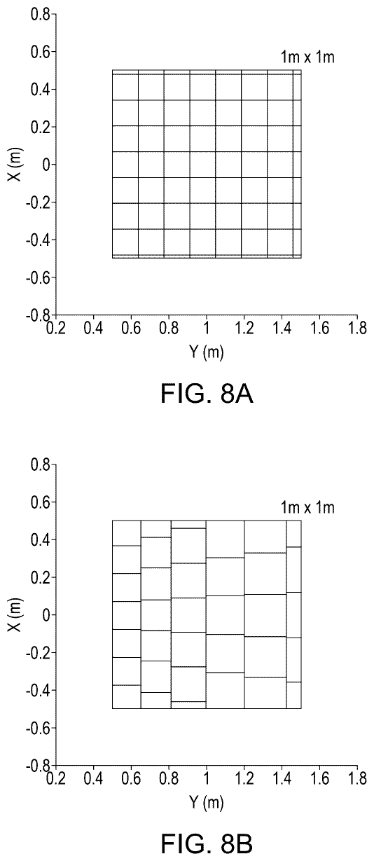

The limits on the size of the scene cluster r_{cs} increase as r_{oc} increases, i.e. as the distance of the scene cluster from the array increases. This allows for the scene to be subdivided into non-uniform clusters, with cluster size increasing as the distance from the array increases. FIGS. 8A and 8B illustrate examples of uniform and non-uniform subdivision respectively. When imaging a large volume, the non-uniform subdivision can reduce the number of scene clusters, and hence reduce the amount of exact distances which need to be determined.

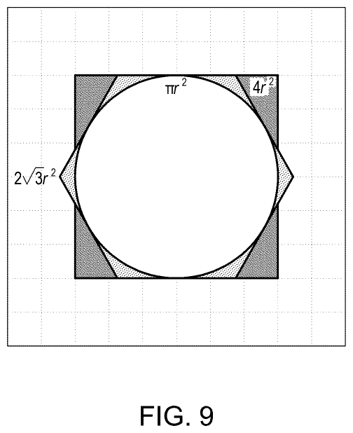

Additionally, the size of a cluster is defined by its maximum radius to form a circle. When subdividing the array and scene volumes into squares or cubes, the approximation error increases further away from the centre, at the corners. Therefore, the array and scene clusters can be subdivided into hexagons, for more efficient space packing of clusters. FIG. 9 plots the square and hexagon which inscribe a circle of radius r. 21% of the square lies outside of the radius r, resulting in an approximation error that is higher than required. For comparison, only 9% of the hexagon is above the error margin.

By comparison of average processing times, the proposed quadratic approximation runs 50% faster than computing the exact distances between all array and scene resolution cells. Moreover, the linear approximation reduces the computation time by 90% within a single cluster. However, due to the smaller clusters required to maintain an acceptable size of the approximation error, the number of subdivisions required to operate using the linear approximation limits the computational gains achieved in comparison to the quadratic approximation.

By expanding the square root expression using Taylor series, some of the terms in the approximation can remain constant depending on the type of motion imaged. Therefore, in cases where there is only translation or only rotation, the expression of the approximation can be simplified further.

The advantages of the proposed method are presented through a mmWave radar imaging example. The wavelength used in this example is λ_{c}, =3.8 mm. The array cluster is a square with 48 half-wavelength spaced elements located along each of its four sides. The number of MIMO virtual elements therefore is 4×48=9216. The scene volume is a cube of side 200 mm.

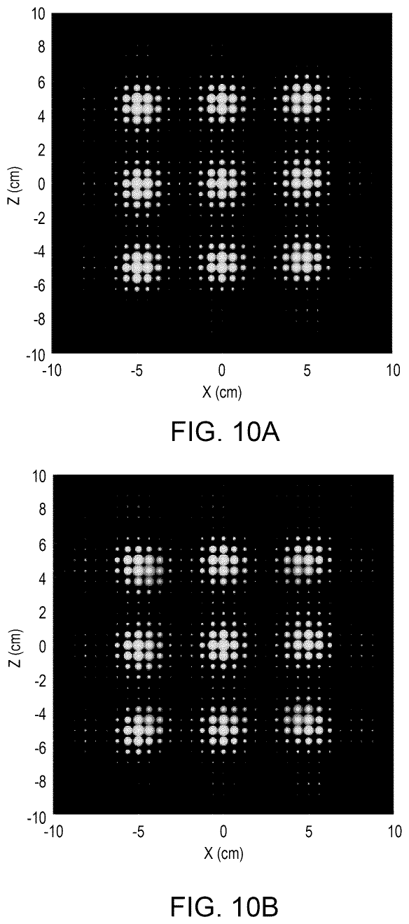

The first simulation, depicted in FIGS. 10A and 10B, consisted of imaging 27 scatterers located within a cube of side 100 mm. FIG. 10A depicts the image formed using the exact computation, while FIG. 10B uses the proposed approximation. Image quality metrics, namely entropy and contrast, were determined to be comparable, with the exact computation having an Entropy value of 0.93 and Contrast value of 1.35, and the proposed approximation having an Entropy value of 0.94 and Contrast value of 1.34.

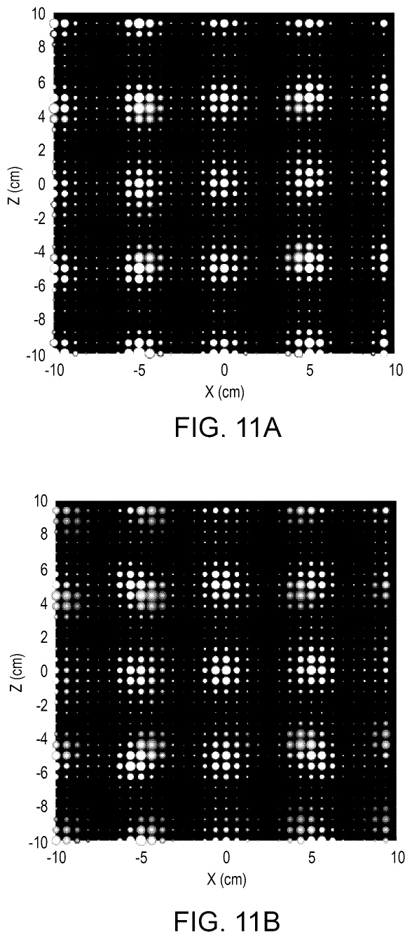

The second simulation, depicted in FIGS. 11A and 11B, consisted of imaging 125 scatterers located within a larger cube of 200 mm, to populate the scene volume. FIG. 11A depicts the image formed using the exact computation, while FIG. 11B uses the proposed approximation. Image quality metrics, namely entropy and contrast, were again determined to be comparable, with the exact computation having an Entropy value of 0.97 and Contrast value of 0.86, and the proposed approximation having an Entropy value of 0.97 and Contrast value of 0.83. Although the metrics are comparable, some artifacts can be noticed on the edges of the approximated image. Therefore, for a scene volume larger than derived maximum size, the approximation error increases and slowly deteriorates the quality of the images at the edges.

While certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A method of processing radar reflection data received at an antenna array, the antenna array comprising a plurality of antenna elements grouped into at least one array cluster, the radar reflection data being representative of a scene, the scene comprising a plurality of scene resolution cells, the method comprising, for each antenna element:
match-filtering the radar reflection data received at the antenna element against a signal model to produce image data, wherein the signal model is calculated using approximated distances between the antenna element and each scene resolution cell, wherein the approximated distance between the antenna element and each scene resolution cell is determined using a distance measured from the centre of the array cluster containing the antenna element.

2. The method of claim 1, wherein the plurality of scene resolution cells are grouped into at least one scene cluster, and wherein the approximated distance between the antenna element and each scene resolution cell is determined using a distance measured from the centre of the array cluster containing the antenna element to a centre of the scene cluster containing the scene resolution cell.

3. The method of claim 2, wherein the approximated distance rₐₛ is calculated as:
$${r}_{as} ( n ) \approx {r}_{oc} \times ( 1 + {η}_{cs} α ( n ) + {η}_{oa} β ( n ) ) ,$$
wherein
r_{oc} is the measured distance between the centre of the array cluster and the centre of the scene cluster,
η_{CS} is a ratio between (i) a distance of the scene resolution cell to the centre of the scene cluster and (ii) the measured distance,
ηₒₐ is a ratio between (i) a distance of the antenna element to the centre of the array cluster and (ii) the measured distance,
α(n) is the cosine of the angle formed between the centre of the array cluster, the centre of the scene cluster, and the scene resolution cell, and
β(n) is the cosine of the angle formed between the antenna element, the centre of the array cluster and the centre of the scene cluster.

4. The method of claim 2, wherein the approximated distance rₐₛ is calculated as:
$${r}_{as} ( n ) \approx {r}_{oc} \times ( 1 + {η}_{cs} α ( n ) + {η}_{oa} β ( n ) + \frac{{η}_{cs}^{2}}{2} ( 1 - {α ( n )}^{2} ) + \frac{{η}_{oa}^{2}}{2} ( 1 - {β ( n )}^{2} ) + {η}_{oa} {η}_{cs} ( γ ( n ) - α ( n ) β ( n ) ) )$$
wherein
r_{oc} is the measured distance between the centre of the array cluster and the centre of the scene cluster,
η_{cs} is a ratio between (i) a distance of the scene resolution cell to the centre of the scene cluster and (ii) the measured distance,
ηₒₐ is a ratio between (i) a distance of the antenna element to the centre of the array cluster and (ii) the measured distance,
α(n) is the cosine of the angle formed between the centre of the array cluster, the centre of the scene cluster, and the scene resolution cell,
β(n) is the cosine of the angle formed between the antenna element, the centre of the array cluster and the centre of the scene cluster, and
γ(n) is the cosine of the angle formed between (i) the vector spanning from the antenna element to the centre of the array cluster, and (ii) the vector spanning from the centre of the scene cluster to the scene resolution cell.

5. The method of claim 2, wherein the plurality of scene resolution cells are grouped into a plurality of scene clusters, wherein a size of a scene cluster increases as its measured distance from the array cluster increases.

6. The method of claim 2, wherein at least one of the array clusters, and/or at least one of the scene clusters, is hexagonally shaped.

7. The method of claim 2, wherein the radar reflection data comprises reflections obtained from a pulse signal emitted from the radar towards the scene, and wherein the method is performed for a plurality of emitted pulse signals.

8. The method of claim 2, wherein the antenna array is a MIMO radar, and/or the plurality of antenna elements are mmWave antenna elements.

9. A non-transitory computer-readable medium comprising computer executable instructions that when executed by a computer will cause the computer to:
for each antenna element of an antenna array, the antenna array comprising a plurality of antenna elements grouped into at least one array cluster:
match-filter radar reflection data received at the antenna element, the radar reflection data being representative of a scene comprising a plurality of scene resolution cells, the match-filtering against a signal model to produce image data, wherein the signal model is calculated using approximated distances between the antenna element and each scene resolution cell, wherein the approximated distance between the antenna element and each scene resolution cell is determined using a distance measured from the centre of the array cluster containing the antenna element.

10. The non-transitory computer-readable medium of claim 9, wherein the plurality of scene resolution cells are grouped into at least one scene cluster, and wherein the approximated distance between the antenna element and each scene resolution cell is determined using a distance measured from the centre of the array cluster containing the antenna element to a centre of the scene cluster containing the scene resolution cell.

11. The non-transitory computer-readable medium of claim 10, wherein the approximated distance rₐₛ is calculated as:
$${r}_{as} ( n ) \approx {r}_{oc} \times ( 1 + {η}_{cs} α ( n ) + {η}_{oa} β ( n ) ) ,$$
wherein
r_{oc} is the measured distance between the centre of the array cluster and the centre of the scene cluster,
η_{cs} is a ratio between (i) a distance of the scene resolution cell to the centre of the scene cluster and (ii) the measured distance,
ηₒₐ is a ratio between (i) a distance of the antenna element to the centre of the array cluster and (ii) the measured distance,
α(n) is the cosine of the angle formed between the centre of the array cluster, the centre of the scene cluster, and the scene resolution cell, and
β(n) is the cosine of the angle formed between the antenna element, the centre of the array cluster and the centre of the scene cluster.

12. The non-transitory computer-readable medium of claim 10, wherein the approximated distance rₐₛ is calculated as:
$${r}_{as} ( n ) \approx {r}_{oc} \times ( 1 + {η}_{cs} α ( n ) + {η}_{oa} β ( n ) + \frac{{η}_{cs}^{2}}{2} ( 1 - {α ( n )}^{2} ) + \frac{{η}_{oa}^{2}}{2} ( 1 - {β ( n )}^{2} ) + {η}_{oa} {η}_{cs} ( γ ( n ) - α ( n ) β ( n ) ) )$$
wherein
r_{oc} is the measured distance between the centre of the array cluster and the centre of the scene cluster,
η_{cs} is a ratio between (i) a distance of the scene resolution cell to the centre of the scene cluster and (ii) the measured distance,
ηₒₐ is a ratio between (i) a distance of the antenna element to the centre of the array cluster and (ii) the measured distance,
α(n) is the cosine of the angle formed between the centre of the array cluster, the centre of the scene cluster, and the scene resolution cell,
β(n) is the cosine of the angle formed between the antenna element, the centre of the array cluster and the centre of the scene cluster, and
γ(n) is the cosine of the angle formed between (i) the vector spanning from the antenna element to the centre of the array cluster, and (ii) the vector spanning from the centre of the scene cluster to the scene resolution cell.

13. The non-transitory computer-readable medium of claim 10, wherein the plurality of scene resolution cells are grouped into a plurality of scene clusters, wherein a size of a scene cluster increases as its measured distance from the array cluster increases.

14. The non-transitory computer-readable medium of claim 10, wherein at least one of the array clusters, and/or at least one of the scene clusters, is hexagonally shaped.

15. The non-transitory computer-readable medium of claim 10, wherein the radar reflection data comprises reflections obtained from a pulse signal emitted from the radar towards the scene, and wherein the method is performed for a plurality of emitted pulse signals.

16. The non-transitory computer-readable medium of claim 10, wherein the antenna array is a MIMO radar, and/or the plurality of antenna elements are mmWave antenna elements.

17. A system configured to process radar reflection data received at an antenna array, the antenna array comprising a plurality of antenna elements grouped into at least one array cluster, the radar reflection data being representative of a scene, the scene comprising a plurality of scene resolution cells, the method comprising, for each antenna element:
match-filtering the radar reflection data received at the antenna element against a signal model to produce image data, wherein the signal model is calculated using approximated distances between the antenna element and each scene resolution cell, wherein the approximated distance between the antenna element and each scene resolution cell is determined using a distance measured from the centre of the array cluster containing the antenna element.

18. The system of claim 17, wherein the plurality of scene resolution cells are grouped into at least one scene cluster, and wherein the approximated distance between the antenna element and each scene resolution cell is determined using a distance measured from the centre of the array cluster containing the antenna element to a centre of the scene cluster containing the scene resolution cell.

19. The system of claim 18, wherein the plurality of scene resolution cells are grouped into a plurality of scene clusters, wherein a size of a scene cluster increases as its measured distance from the array cluster increases.

20. The system of claim 18, wherein at least one of the array clusters, and/or at least one of the scene clusters, is hexagonally shaped.
